(19) United States
(12) Patent Application Publication
(10) Pub. No.: US 2012/0263917 A1
(43) Pub. Date: Oct. 18, 2012

(54) OPTICAL MODULE HAVING TO-CAN STRUCTURE FOR HIGH-SPEED SIGNAL TRANSMISSION

(75) Inventors: Sae-Kyoung KANG, Daejeon (KR); Joon Ki LEE, Daejeon (KR); Joon Young HUH, Daejeon (KR)

(73) Assignee: Electronics and Telecommunications Research Institute, Daejeon (KR)

(21) Appl. No.: 13/442,371

(22) Filed: Apr. 9, 2012

(30) Foreign Application Priority Data
Apr. 13, 2011 (KR) 10-2011-0034320

(51) Int. Cl. B32B 3/10

(52) U.S. Cl. 428/138

(57) ABSTRACT

There is provided an optical module having a top open can (TO-CAN) structure. The optical module having the TO-CAN structure includes a stem that accommodates an optical element or an electronic element therein, and a lead pin that is connected to the optical element or the electronic element through a hole of the stem, wherein the lead pin is bent in a “ [symbol] ” shaped structure. Accordingly, the optical module with the TO-CAN structure may operate at high speed and be manufactured at low cost.

### CROSS-REFERENCE TO RELATED APPLICATION

This application claims the benefit under 35 U.S.C. §119(a) of a Korean Patent Application No. 10-2011-0034320, filed on Apr. 13, 2011, the entire disclosure of which is incorporated herein by reference for all purposes.

### BACKGROUND

1. Field

The following description relates to optical communication technology, and more particularly, to an optical module having a top open can (TO-CAN) structure.

2. Description of the Related Art is An optical communication network is being widely used along with the development and diffusion of optical fibers, optical amplifiers, and various types of optical modules for optical transmission/reception. In particular, recently, an ultra high speed optical communication system capable of supporting a data transfer rate of 100 GHz or more has been developed and used to meet increasing requirements for a large amount of data traffic. Optical modules developed so far include a butterfly structure in which elements are integrated on a flat type substrate, a TO-CAN structure that covers the upper surface of a stem on which active elements for optical transmission/reception are integrated, etc. Among these, an optical module with the TO-CAN structure is being widely used in various ultra high speed optical communication systems since it can be manufactured at low cost.

However, with the speed-up and miniaturization of optical communication systems, the optical module with the TO-CAN structure has limitation in its electrical characteristics upon application to a system that supports a data transfer rate of 10 Gbps or more. In a lead pin for signal line, which is used in most of TO-CAN structures, a part electrically connected to an optical element or an electronic element is in a nailhead shape or in a straight-line shape in order to ensure a flat surface such that the part is exposed to air from a TO-CAN body and a dielectric (made of a glass material or the like) to allow wire-bonding.

However, in the above-described structure, impedance discontinuity may occur in high frequency regions since the inductance of the part exposed to air mismatches the inductance of wire-bonding for electrical connection between the optical or electronic element and the lead pin. Such impedance may have bad influence on signal integrity and distort signal waveforms. Particularly, since transmission loss and reflection values increase in high frequency regions, there are difficulties in using the conventional structure in optical communication systems.

### SUMMARY

The following description relates to an optical module having a top open can (TO-CAN) packaged structure, which is capable of operating at high speed and being manufactured at low cost by improving a lead pin for signal line.

In one general aspect, there is provided an optical module having a top open can (TO-CAN) structure, the optical module including a stem that accommodates an optical element or an electronic element therein, and a lead pin that is connected to the optical element or the electronic element through a hole of the stem, wherein the lead pin is bent in a “ [symbol] ”-shaped structure.

The lead pin may include: a first part configured to have predetermined line width and length and to be exposed to the outside of the stem; and a second part configured to be connected to the first part and to be positioned in the inside of the stem. The length of the first part may be set to minimize a distance to the optical element or the electronic element, and the line width s of the first part is set to minimize transmission loss and reflection values. The first part may be wire-bonded to the optical element or the electronic element through a lead.

The lead pin may be positioned to the center of the stem in order to minimize a distance to the optical element or the electronic element. The optical module may further include a pair of ground plates configured to be disposed in both sides of the lead pin on the stem.

Therefore, according to the optical module described above, since the lead pin for signal line in the TO-CAN packaged structure is designed to have a minimized length of wire bonding for electrical connection with an optical or electronic element, high-speed signal transmission may be achieved. Furthermore, low-cost, high-speed transmission may be implemented through the optical module capable of being manufactured with the same materials as those used is in a general optical module manufacturing process.

Other features and aspects will be apparent from the following detailed description, the drawings, and the claims.

### BRIEF DESCRIPTION OF THE DRAWINGS

FIG. 1 is a perspective view illustrating an example of an optical module having a top open can (TO-CAN) packaged structure.

FIG. 2 illustrates a lead pin for signal line included in the optical module of FIG. 1.

FIG. 3 is a graph showing the simulation results of transmission loss and reflection values with respect to frequency about the optical module with the TO-CAN packaged structure illustrated in FIG. 1.

FIG. 4 is a perspective view illustrating another example of an optical module having a TO-CAN structure.

FIG. 5 is a graph showing the simulation results of transmission loss and reflection values with respect to frequency about the optical module with the TO-CAN packaged structure illustrated in FIG. 4.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

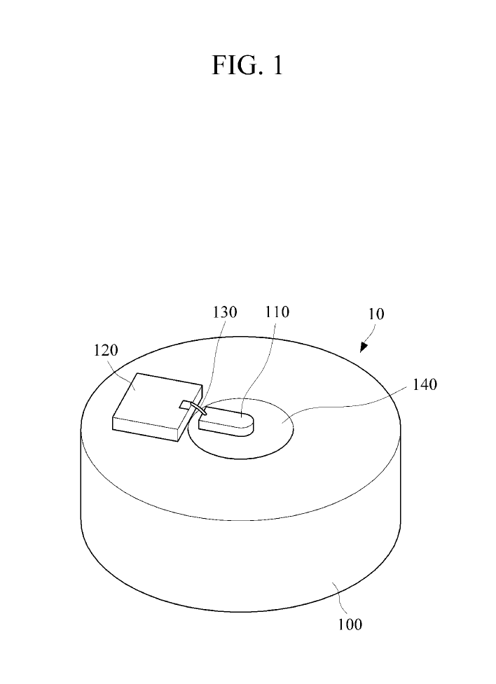

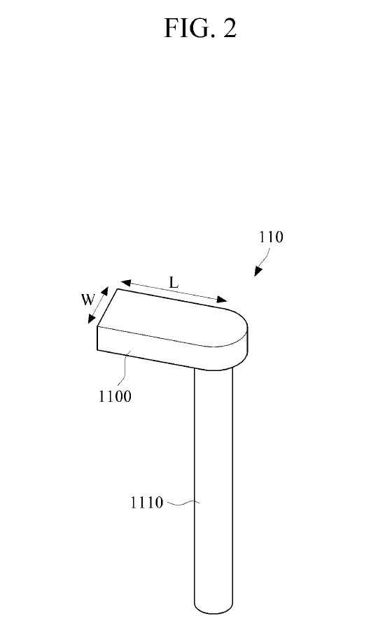

is The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness. FIG. 1 is a perspective view illustrating an example of an optical module 10 having a top open can (TO-CAN) packaged structure, and FIG. 2 illustrates a lead pin 110 for signal line included in the optical module 10 of FIG. 1.

FIGS. 1 and 2 do not show all components of the optical module 10, and the following description is given only in regard of components influencing the configuration and operation of the optical module 10. In detail, in the current example, only the lead pin 110 will be described in detail since the structure of the lead pin 110 makes the technical feature of the current example although the optical module 10 is composed of a power supply, a control/monitoring unit, two signal pins, a ground pin, etc.

Referring to FIG. 1, a hole is formed in a stem 100 of the TO-CAN packaged structure such that the hole penetrates the stem 100 and a part of the lead pin 110 for signal line is inserted into the hole. There may be a plurality of holes. In the case of an optical receiver module, an optical/electronic element 120 for converting received optical signal into current, and a dielectric 140 are positioned on the stem 100. The TO-CAN packaged structure is suitable for optical modules that can support a high data transfer rate of 25 Gbps, 100 Gbps or more.

Generally, leads are wire-bonded for electrical connections between optical or electronic elements and lead pins for signal line, and such wire-bonding tends to need long leads. However, long leads may cause impedance discontinuity in high frequency regions and have bad influence on signal integrity. As a result, signal waveforms may be distorted. Particularly, transmission loss and reflection values significantly increase in high frequency regions, which may make limitation in use of the optical module.

In order to overcome the problem, the lead pin 110 for signal line according to the current example has a “ [symbol] ”-shaped structure as shown in FIG. 2. Referring to FIG. 2, the lead pin 110 includes a first part 1100 and a second part 1110, wherein the first part 1100 has predetermined line width W and length L and is exposed to the outside of the stem 100, and the second part 1110 is connected to the first part 1100 and positioned in the inside of the stem 100.

According to an example, the length (L) of the first part 1100 is set to minimize the distance between the optical/electronic element 120 and the lead pin 110, and also the line width W of the first part 1100 is set to minimize transmission loss and reflection values. The first part 1100 is wire-boned to the optical/electronic element 120 through a lead 130. According to another aspect, the lead pin 110 is disposed in the center of the stem 100 in order to minimize the distance to the optical/electronic element 120.

As illustrated in FIGS. 1 and 2, since the lead pin 110 has a “ [symbol] ”-shaped structure, the length of the lead 130 wire-bonded for electrical connection with the optical/electronic element 120 may be reduced, resulting in improvement of frequency characteristics.

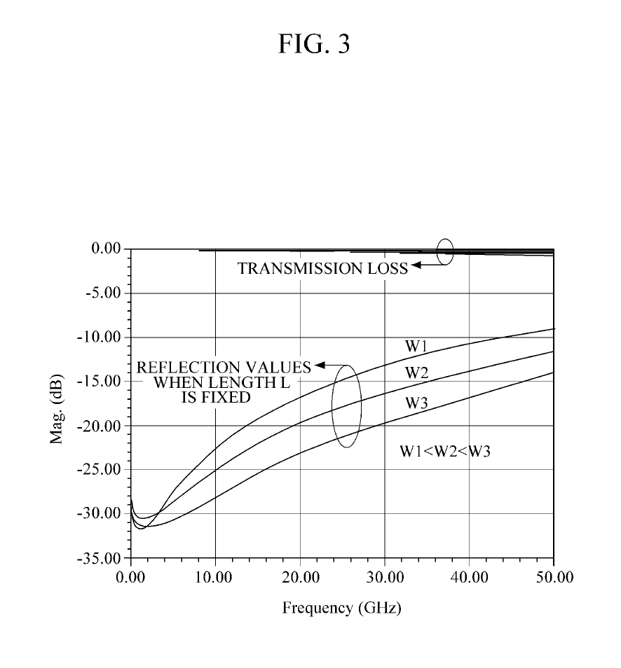

FIG. 3 is a graph showing the simulation results of transmission loss and reflection values with respect to frequency about the optical module 10 with the TO-CAN packaged structure illustrated in FIG. 1, wherein the simulation may be performed with HFSS which is a 3D 15 electromagnetic (EM) simulation tool developed by ANSYS, Inc.

FIG. 3 relates to the simulation results obtained when changing the line width W (W1<W2<W3) while fixing the length L of the lead pin 110 such that the length of the lead 130 for wire-bonding is minimized. Referring to FIG. 3, if the line width W is W3, the transmission loss is measured to be lower than 0.5 dB upto 50 GHz and the reflection values are measured to be lower than −13 dB upto 50 GHz.

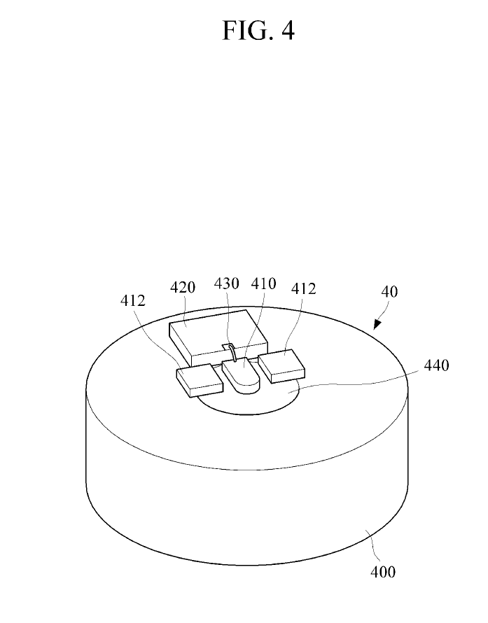

FIG. 4 is a perspective view illustrating another example of an optical module 40 having a TO-CAN structure.

Referring to FIG. 4, the optical module 40 further includes a pair of ground plates (412 for each), compared to the optical module 10 described above with reference to FIG. 1. In other words, a hole is formed in a stem 400 of a TO-CAN packaged structure such that the hole penetrates the stem 400 and a part of a lead pin 410 for signal line is inserted in the hole. There may be a plurality of holes. In the case of an optical receiver module, an optical/electronic element 420 for converting received optical signals into current, and a dielectric 440 are positioned on the stem 400. The lead pin 410 for signal line has a “ [symbol] ”-shaped structure, and includes a part having predetermined line width W and length L and exposed to the outside of the stem 400, and another part being in a straight line shape and positioned in the inside of the stem 400.

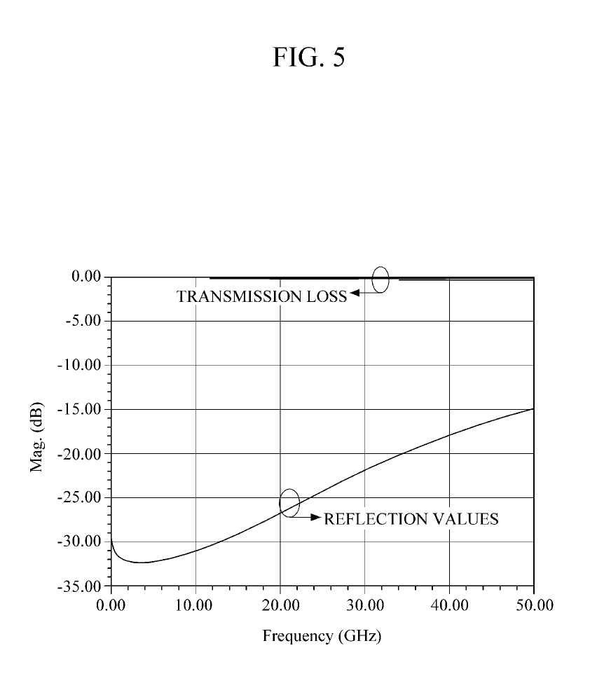

The ground plates 412 are packaged respectively in both sides of the bent part of the lead pin 410 in order to help high-speed signal transmission. When the ground plates 412 are packaged with a specific width W therebetween respectively in both sides of the lead pin 410, excellent characteristics as seen in FIG. 5 can be obtained. In the lead pin 410 having the “ [symbol] ”-shaped structure, the line width W and length L are set to minimize the length of a lead 430 for wire-bonding upon electrical connection between the optical/electronic element 420 and the lead pin 410.

It is seen from FIG. 5 that transmission loss of the optical module 40 with the TO-CAN packaged structure as illustrated in FIG. 4 is measured to be lower than 0.3 dB upto 50 GHz and reflection values thereof are measured to be lower than −14 dB upto 50 GHz.

The present invention can be implemented as computer readable codes in a computer readable record medium. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An optical module having a top open can (TO-CAN) structure, the optical module including a stem that accommodates an optical element or an electronic element therein, and a lead pin that is connected to the optical element or the electronic element through a hole of the stem, wherein the lead pin is bent in a “ [symbol] ”-shaped structure.

2. The optical module of claim 1, wherein the lead pin comprises:
a first part configured to have predetermined line width and length and to be exposed to the outside of the stem; and
a second part configured to be connected to the first part and to be positioned in the inside of the stem.

3. The optical module of claim 2, wherein the length of the first part is set to minimize a distance to the optical element or the electronic element, and the line width of the first part is set to minimize transmission loss and reflection values.

4. The optical module of claim 2, wherein the first pat is wire-bonded to the optical element or the electronic element through a lead.

5. The optical module of claim 1, wherein the lead pin is positioned to the center of the stem in order to minimize a distance to the optical element or the electronic element.

6. The optical module of claim 1, wherein the optical module further comprises a pair of ground plates configured to be disposed in both sides of the lead pin on the stem.

7. The optical module of claim 1, wherein the optical module has a data transfer rate of 100 Gbps or more.
